(19) United States
(12) Patent Application Publication
(10) Pub. No.: US 2017/0190234 A1
(43) Pub. Date: Jul. 6, 2017

(54) AIR CONDITIONING SYSTEM FOR MOTOR VEHICLES

(71) Applicant: HANON SYSTEMS, Daejeon (KR)

(72) Inventors: Chan Joo Maeng, Daejeon (KR); Min Woong Kang, Daejeon (KR); Dae Woong Lee, Daejeon (KR); Jin Kuk Kim, Daejeon (KR); Heon Hur, Daejeon (KR)

(73) Assignee: HANON SYSTEMS, Daejeon (KR)

(21) Appl. No.: 15/122,531

(22) PCT Filed: Sep. 22, 2015
(86) PCT No.: PCT/KR2015/009958

§ 371 Date: Aug. 30, 2016

(30) Foreign Application Priority Data
Sep. 23, 2014 (KR) 10-2014-0126646

(51) Int. Cl. B60H 1/00

(52) U.S. Cl. CPC B60H 1/00849; B60H 1/00764; B60H 1/0075; B60H 1/00785

(57) ABSTRACT

An air conditioning system for motor vehicles includes an air conditioner case having an external air introduction port and an internal air introduction port, an intake door rotatably installed in the air conditioner case so as to open the external air introduction port in an external air mode and open the internal air introduction port in an internal air mode, a blower configured to draw an internal air or an external air through the external air introduction port or the internal air introduction port and to blow the internal air or the external air into a vehicle room, and a control unit configured to control the intake door to move in such a direction as to close the external air introduction port and to restrain entry of rainwater into the external air introduction port, if a rotation speed level of the blower satisfies a predetermined condition in the external air mode.

### CROSS-REFERENCE TO RELATED PATENT APPLICATIONS

This patent application is a United States national phase patent application based on PCT/KR2015/009958 filed Sep. 22, 2015, which claims the benefit of Korean Patent Application No. 10-2014-0126646 filed Sep. 23, 2014, the disclosures of which are hereby incorporated herein by reference in their entirety.

### TECHNICAL FIELD

The present invention relates to an air conditioning system for motor vehicles. More particularly, the present invention pertains to an air conditioning system for motor vehicles which is configured to restrain rainwater existing outside a vehicle room from flowing into an external air introduction port of an air conditioner case in case of rain and which is capable of preventing the failure, damage and erroneous operation of various kinds of electric devices and components due to the introduction of rainwater.

### BACKGROUND ART

A motor vehicle is provided with an air conditioning system for cooling or heating the interior of a vehicle room. As shown in FIG. 1, an air conditioning system includes an air conditioner case 10 having an external air introduction port 12 and an internal air introduction port 14. The external air introduction port 12 communicates with the exterior of a vehicle room through an air intake port 16a of a cowl 16 and introduces an air existing outside the vehicle room. The internal air introduction port 14 communicates with the interior of the vehicle room and introduces an air existing within the vehicle room.

The air conditioning system further includes an intake door 18 installed between the external air introduction port 12 and the internal air introduction port 14. The intake door 18 is formed in a dome-like shape and is rotatably attached to the air conditioner case 10. Specifically, the intake door 18 selectively opens the external air introduction port 12 and the internal air introduction port 14 while making rotational movement between an external air mode position (A) and an internal air mode position (B). This enables an external air and an internal air to be selectively introduced into the air conditioning system.

The air conditioning system further includes a blower 20 which draws an internal air or an external air through the external air introduction port 12 or the internal air introduction port 14 and blows the internal air or the external air into the vehicle room.

The air conditioning system of the related art mentioned above has a disadvantage in that rainwater existing outside the vehicle room may be introduced into the external air introduction port 12 together with the external air in case of rain. This may lead to a failure or an erroneous operation of different components disposed within the air conditioner case 10. In the case of a semi-bonnet type or rear-engine type commercial vehicle, the distance from the air intake port 16a of the cowl 16 to the external air introduction port 12 is relatively short. Thus, it is highly likely that the external rainwater is introduced into the external air introduction port 12.

When the travel speed of the motor vehicle is high or when the rotation speed level of the blower 20 is high, the introduction angle of rainwater grows larger and the intake force of rainwater becomes larger. This accelerates the introduction of rainwater into the external air introduction port 12. This poses a problem in that various kinds of components existing within the air conditioner case 10 may suffer from a failure or an erroneous operation.

In particular, the rainwater introduced into the external air introduction port 12 may be infiltrated into internal electric components such as the blower 20 or the like, thereby generating short circuit. As a result, various kinds of electric components may be damaged or broken down.

### SUMMARY OF THE INVENTION

### Problems to be Solved

In view of the aforementioned problems inherent in the related art, it is an object of the present invention to provide an air conditioning system for motor vehicles which is capable of restraining rainwater existing outside a vehicle room from flowing into an external air introduction port of an air conditioner case in case of rain.

Another object of the present invention is to provide an air conditioning system for motor vehicles which is configured to restrain rainwater existing outside a vehicle room from flowing into an external air introduction port of an air conditioner case in case of rain and which is capable of preventing the failure, damage and erroneous operation of various kinds of electric devices and components due to the introduction of rainwater.

### Technical Solutions

In order to achieve the above objects, there is provided an air conditioning system for motor vehicles, including: an air conditioner case having an external air introduction port and an internal air introduction port; an intake door rotatably installed in the air conditioner case so as to open the external air introduction port in an external air mode and open the internal air introduction port in an internal air mode; a blower configured to draw an internal air or an external air through the external air introduction port or the internal air introduction port and to blow the internal air or the external air into a vehicle room; and a control unit configured to control the intake door to move in such a direction as to close the external air introduction port and to restrain entry of rainwater into the external air introduction port, if a rotation speed level of the blower satisfies a predetermined condition in the external air mode.

In the air conditioning system, the control unit may be configured to enter a rainwater cutoff mode and to control the intake door in such a direction as to close the external air introduction port, if the rotation speed level of the blower is equal to or higher than a predetermined reference rotation speed level in the external air mode.

In the air conditioning system, the control unit may be configured to control the intake door to move in such a direction as to close the external air introduction port and to restrain entry of rainwater into the external air introduction port, if a vehicle driving speed satisfies a predetermined condition in the external air mode.

In the air conditioning system, the control unit may be configured to enter the rainwater cutoff mode and to control the intake door in such a direction as to close the external air introduction port, if the vehicle driving speed is equal to or higher than a predetermined reference vehicle speed in the external air mode and if the rotation speed level of the blower is equal to or higher than the predetermined reference rotation speed level in the external air mode.

The air conditioning system may further include: a rain detection unit configured to detect whether it is raining, wherein the control unit may be configured to enter the rainwater cutoff mode and to control the intake door in such a direction as to close the external air introduction port, only when the rain detection unit detects that it is raining, even if the vehicle driving speed is equal to or higher than the reference vehicle speed and even if the rotation speed level of the blower is equal to or higher than the reference rotation speed level.

In the air conditioning system, the control unit may be configured to control the intake door to move in such a direction as to close the external air introduction port when entering the rainwater cutoff mode and may be configured to control the intake door to move toward a position between the external air introduction port and the internal air introduction port so that the external air introduction port is partially closed.

### Advantageous Effects

According to the present air conditioning system for motor vehicles, if the weather condition and the driving condition satisfy predetermined conditions, it is determined that rainwater existing outside the vehicle room may possibly be introduced into the external air introduction port. In this case, the external air introduction port is partially closed. It is therefore possible to reliably restrain rainwater existing outside the vehicle room from flowing into the external air introduction port of the air conditioner case in case of rain.

Furthermore, since the air conditioning system is configured to restrain rainwater existing outside the vehicle room from flowing into the external air introduction port of the air conditioner case in case of rain, it is possible to prevent the failure, damage and erroneous operation of various kinds of electric devices and components due to the introduction of rainwater.

### BRIEF DESCRIPTION OF THE DRAWINGS

FIG. 1 is a view showing a conventional air conditioning system for motor vehicles.

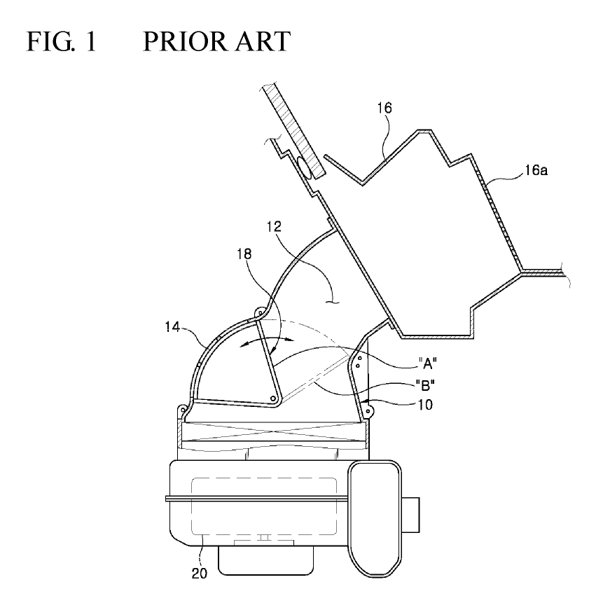

FIG. 2 is a view illustrating an air conditioning system for motor vehicles according to a first embodiment of the present invention.

FIG. 3 is a view illustrating an operation example of the air conditioning system for motor vehicles according to the first embodiment of the present invention.

FIG. 4 is a flowchart illustrating an operation example of the air conditioning system for motor vehicles according to the first embodiment of the present invention.

FIG. 5 is a view illustrating an air conditioning system for motor vehicles according to a second embodiment of the present invention.

FIG. 6 is a view illustrating an air conditioning system for motor vehicles according to a third embodiment of the present invention.

FIG. 7 is a flowchart illustrating an operation example of the air conditioning system for motor vehicles according to the third embodiment of the present invention.

### MODE FOR CARRYING OUT THE INVENTION

In the air conditioning system, the control unit may be configured to control the intake door to move in such a direction as to close the external air introduction port when entering the rainwater cutoff mode and may be configured to control the intake door to move toward a position between the external air introduction port and the internal air introduction port so that the external air introduction port is partially closed.

Preferred embodiments of an air conditioning system for motor vehicles according to the present invention will now be described in detail with reference to the accompanying drawings. Components similar to those of the related art described earlier will be designated by like reference symbols.

### First Embodiment

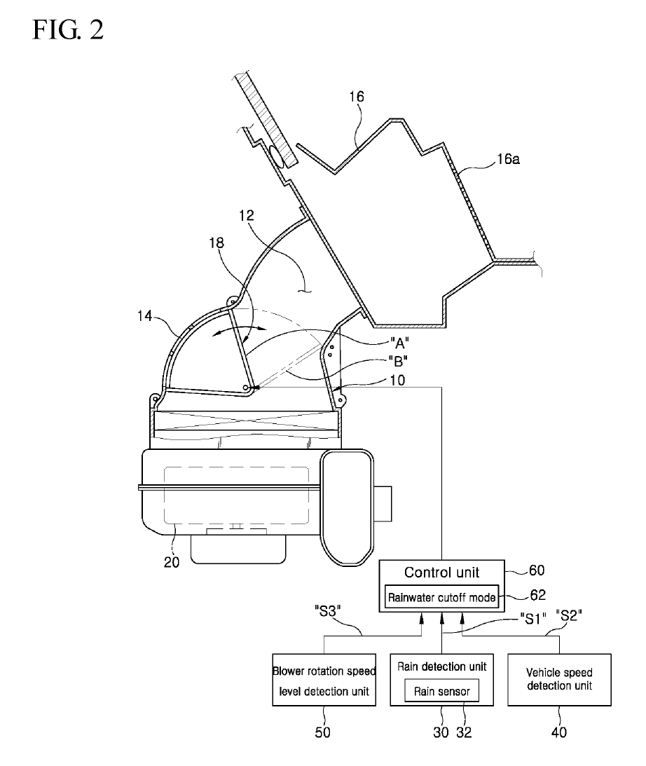

Prior to describing features of an air conditioning system for motor vehicles according to the present invention, an air conditioning system for motor vehicles will be briefly described with reference to FIG. 2.

The air conditioning system includes an air conditioner case 10 having an external air introduction port 12 and an internal air introduction port 14. The external air introduction port 12 communicates with the exterior of a vehicle room through an air intake port 16a of a cowl 16 and introduces an air existing outside the vehicle room. The internal air introduction port 14 communicates with the interior of the vehicle room and introduces an air existing within the vehicle room.

The air conditioning system further includes an intake door 18 installed between the external air introduction port 12 and the internal air introduction port 14. The intake door 18 is formed in a dome-like shape and is rotatably attached to the air conditioner case 10. Specifically, the intake door 18 selectively opens the external air introduction port 12 and the internal air introduction port 14 while making rotational movement between an external air mode position (A) and an internal air mode position (B). This enables an external air and an internal air to be selectively introduced into the air conditioning system.

The air conditioning system further includes a blower 20 which draws an internal air or an external air through the external air introduction port 12 or the internal air introduction port 14 and blows the internal air or the external air into the vehicle room.

Next, features of a controller of the air conditioning system according to the present invention will be described in detail with reference to FIGS. 2 to 4.

Referring first to FIG. 2, the air conditioning system according to the present invention includes a rain detection unit 30 configured to detect whether it is raining now.

The rain detection unit 30 includes rain sensor 32. The rain sensor 32 is installed on a windshield glass. The rain sensor 32 detects whether it is raining now by detecting a change in a refractive index of light caused by rainwater. Upon detecting rainwater, the rain sensor 32 outputs a rain signal S1 to a control unit 60 which will be described later.

As the rain sensor 32 of the rain detection unit 30, it may be possible to use a conventional rain sensor which is installed to automatically control a windshield wiper. In this case, there is no need to install an additional rain sensor. As a result, it is possible to provide an effect of saving costs.

The air conditioning system further includes a vehicle speed detection unit 40 and a blower rotation speed level detection unit 50. The vehicle speed detection unit 40 is formed of a vehicle speed sensor. The vehicle speed detection unit 40 detects a driving speed of a motor vehicle and then outputs a vehicle speed signal S2 to the control unit 60. The blower rotation speed level detection unit 50 is formed of an automatic control unit (not shown) for automatically controlling the blower 20.

The automatic control unit calculates an optimal blower rotation speed level value depending on internal and external temperatures of a vehicle room and a user-set temperature and automatically controls the rotation speed level of a blower (not shown) depending on the blower rotation speed level value thus calculated. The automatic control unit can detect a current blower rotation speed level through the use of a blower rotation speed level control signal for the automatic control of the blower and can output a blower rotation speed level signal S3 to the control unit 60.

The automatic control unit is provided with a microprocessor and a drive circuit and is well-known in the art. Therefore, detailed descriptions on the automatic control unit will be omitted herein.

Referring again to FIG. 2, the air conditioning system according to the present invention further includes a control unit 60. The control unit 60 is provided with a microprocessor. After the intake door 18 is located in the external air mode position (A), if the vehicle driving speed inputted from the vehicle speed detection unit 40 is equal to or higher than a predetermined reference vehicle speed, if the rotation speed level of the blower 20 inputted from the blower rotation speed level detection unit 50 is equal to or higher than a predetermined reference rotation speed level, and if the rain signal S1 is inputted from the rain detection unit 30, the control unit 60 determines that it is raining now and further determines that rainwater may possibly be introduced into the external air introduction port 12 of the air conditioner case 10 together with an external air.

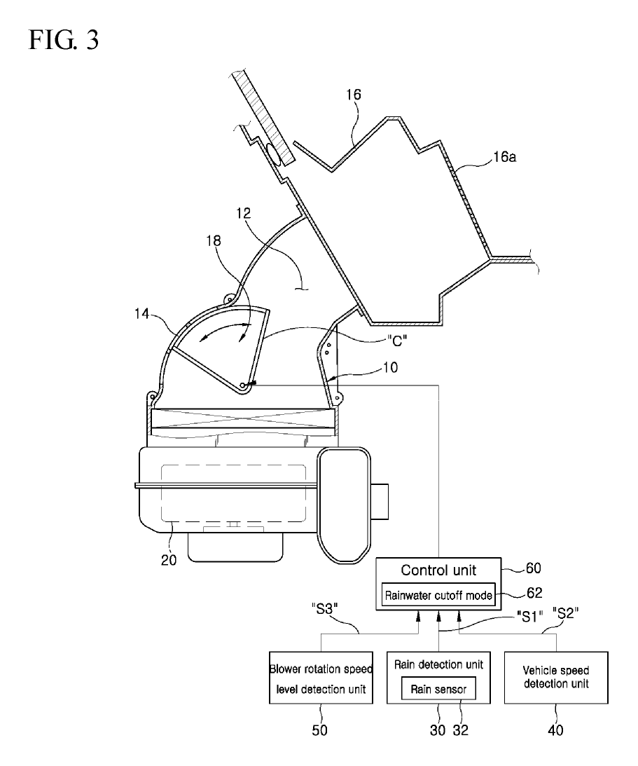

Upon making such determination, the control unit 60 enters a rainwater cutoff mode 62. The control unit 60 entering the rainwater cutoff mode 62 controls the intake door 18 to move toward the internal air mode position (B) as illustrated in FIG. 3. That is to say, the control unit 60 controls the intake door 18 to move in such a direction as to close the external air introduction port 12. Thus, the external air introduction port 12 is closed. This makes it possible to cut off the rainwater which may otherwise be introduced into the external air introduction port 12. As a result, it is possible to prevent the failure, damage and erroneous operation of various kinds of electric devices and components attributable to the introduction of rainwater into the external air introduction port 12.

In the rainwater cutoff mode 62, the control unit 60 controls the intake door 18 to move toward the internal air mode position (B) so that the intake door 18 is not located exactly in the internal air mode position (B) but is located in a middle mode position (C) between the external air mode position (A) and the internal air mode position (B).

The reason for employing this configuration is that even if the external air introduction port 12 is partially closed, it is possible to suppress the introduction of rainwater into the external air introduction port 12. In particular, even if only the upper region of the external air introduction port 12 is closed, it is possible to reliably suppress the introduction of rainwater into the external air introduction port 12.

Preferably, in the rainwater cutoff mode 62, the control unit 60 controls the intake door 18 to move in such a direction as to close the external air introduction port 12 so that the external air introduction port 12 has a closing amount of about 30%. Consequently, the opening amount ratio of the external air introduction port 12 and the internal air introduction port 14 is kept at about 70:30.

On the other hand, after the intake door 18 is controlled to move in such a direction as to close the external air introduction port 12 in the rainwater cutoff mode 62, the control unit 60 is released from the rainwater cutoff mode 62 if the vehicle driving speed inputted from the vehicle speed detection unit 40 is lower than the reference vehicle speed, if the rotation speed level of the blower 20 inputted from the blower rotation speed level detection unit 50 is lower than the reference rotation speed level, if the rain signal S1 inputted from the rain detection unit 30 is eliminated, or if the air intake mode is switched to an internal air mode. The control unit 60 released from the rainwater cutoff mode 62 allows the intake door 18 to return to the original position.

Next, an operation of the air conditioning system configured as above will be described with reference to FIGS. 2 to 4.

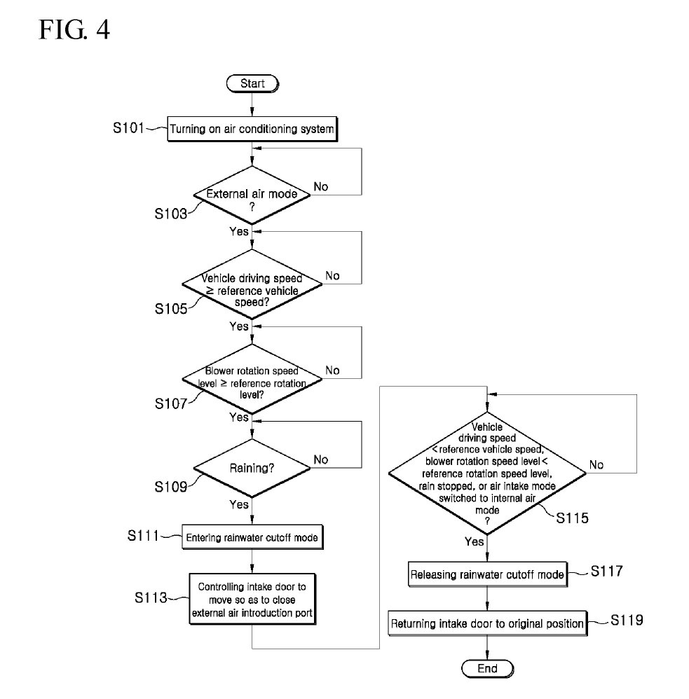

Referring first to FIGS. 4 and 2, the air conditioning system is turned on (S101). In this state, determination is made as to whether the air intake mode of the air conditioning system is an external air mode (S103). If it is determined that the air intake mode of the air conditioning system is the external air mode, determination is made again as to whether the current vehicle driving speed is equal to or higher than a predetermined reference vehicle speed (S105). If it is determined that the current vehicle driving speed is equal to or higher than the reference vehicle speed, the control unit 60 determines again whether the rotation speed level of the blower 20 is equal to or higher than a predetermined reference rotation speed level (S107). If it is determined that the rotation speed level of the blower 20 is equal to or higher than the reference rotation speed level, the control unit 60 determines again whether it is raining now (S109). If it is determined that it is raining now, the control unit 60 enters a rainwater cutoff mode 62 (S111).

As illustrated in FIGS. 4 and 3, the control unit 60 entering the rainwater cutoff mode 62 controls the intake door 18 to move toward the internal air mode position (B), thereby partially closing the external air introduction port 12 (S113).

As the external air introduction port 12 is partially closed, the rainwater existing outside the vehicle room is prevented from flowing into the external air introduction port 12. It is therefore possible to prevent the failure, damage and erroneous operation of various kinds of electric devices and components attributable to the introduction of rainwater into the external air introduction port 12.

Under a state in which the intake door 18 is controlled as above, the control unit 60 determines again whether the vehicle driving speed is lower than the reference vehicle speed, whether the rotation speed level of the blower 20 is lower than the reference rotation speed level, whether the rain is stopped, or whether the air intake mode is switched to an internal air mode (S115).

If it is determined that the vehicle driving speed is lower than the reference vehicle speed, if it is determined that the rotation speed level of the blower 20 is lower than the reference rotation speed level, if it is determined that the rain is stopped, or if it is determined that the air intake mode is switched to the internal air mode, the control unit 60 is released from the rainwater cutoff mode 62 (S117).

The control unit 60 released from the rainwater cutoff mode 62 allows the intake door 18 to return to the original state (S119). Then, the intake door 18 returns to the original position and normally opens or closes the external air introduction port 12.

### Second Embodiment

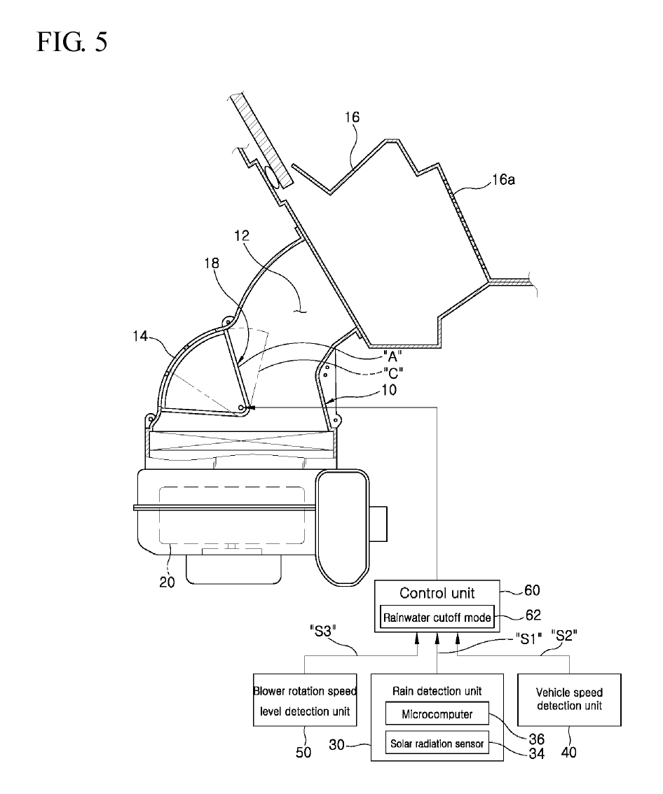

An air conditioning system according to a second embodiment of the present invention will be described with reference to FIG. 5.

In the air conditioning system of the second embodiment, the rain detection unit 30 for detecting rain is formed of a solar radiation sensor 34 and a microcomputer 36. Other configurations of the air conditioning system of the second embodiment are the same as the configurations of the air conditioning system of the first embodiment.

The solar radiation sensor 34 is installed outside the vehicle room and is configured to detect a solar radiation amount. If data on the solar radiation amount is inputted from the solar radiation sensor 34, the microcomputer 36 determines whether the detected solar radiation amount is equal to or smaller than a reference solar radiation amount. If it is determined that the detected solar radiation amount is equal to or smaller than the reference solar radiation amount, the microcomputer 36 determines that it is raining now. Based on this determination, the microcomputer 36 outputs a rain signal S1 to the control unit 60.

In the external air mode, if the rain signal S1 is inputted from the microcomputer 36 of the rain detection unit 30, the control unit 60 compares the vehicle speed data inputted from the vehicle speed detection unit 40 and the blower rotation speed level data inputted from the blower rotation speed level detection unit 50 with reference conditions (a reference vehicle speed and a reference rotation speed level) as in the first embodiment. If all the reference conditions are satisfied, the control unit 60 enters the rainwater cutoff mode 62.

The control unit 60 entering the rainwater cutoff mode 62 controls the intake door 18 to move toward the internal air mode position (B), thereby partially closing the external air introduction port 12.

Thus, the rainwater existing outside the vehicle room is prevented from flowing into the external air introduction port 12. It is therefore possible to prevent the failure, damage and erroneous operation of various kinds of electric devices and components attributable to the introduction of rainwater into the external air introduction port 12.

As the solar radiation sensor 34 of the rain detection unit 30, it is preferable to use a conventional solar radiation sensor installed for the automatic control of the air conditioning system. In this case, there is no need to install an additional solar radiation sensor. As a result, it is possible to provide an effect of saving costs.

The control unit 60 may substitute from the microcomputer 36 of the rain detection unit 30. In this case, the control unit 60 determines whether the detected solar radiation amount inputted from the solar radiation sensor 34 is equal to or smaller than a reference solar radiation amount. If it is determined that the detected solar radiation amount is equal to or smaller than a reference solar radiation amount, the control unit 60 determines that it is raining now.

### Third Embodiment

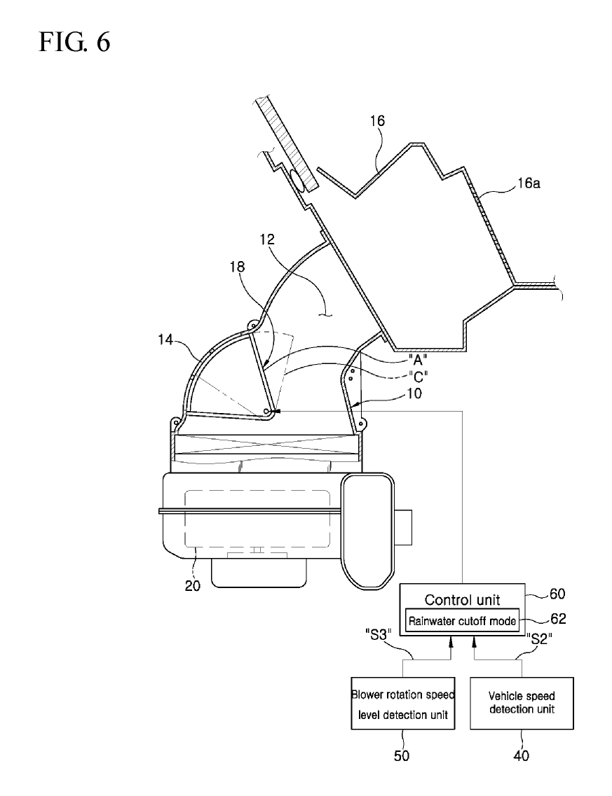

An air conditioning system according to a third embodiment of the present invention will be described with reference to FIG. 6.

Unlike the air conditioning systems of the first and second embodiments, the air conditioning system of the third embodiment does not include the rain detection unit 30 (see FIGS. 2 and 5).

Regardless of the presence or absence of the rain detection unit 30, the control unit 60 compares the vehicle speed data inputted from the vehicle speed detection unit 40 and the blower rotation speed level data inputted from the blower rotation speed level detection unit 50 with pre-stored reference conditions. If all the reference conditions are satisfied, the control unit 60 enters the rainwater cutoff mode 62. The control unit 60 entering the rainwater cutoff mode 62 controls the intake door 18 to move toward the internal air mode position (B), thereby partially closing the external air introduction port 12. Thus, the rainwater existing outside the vehicle room is prevented from flowing into the external air introduction port 12.

After the control unit 60 enters the rainwater cutoff mode 62 and controls the intake door 18 to move in such a direction as to close the external air introduction port 12, the control unit 60 is released from the rainwater cutoff mode 62 if the vehicle driving speed inputted from the vehicle speed detection unit 40 is lower than the reference vehicle speed, if the rotation speed level of the blower 20 inputted from the blower rotation speed level detection unit 50 is lower than the reference rotation speed level, or if the air intake mode is switched to the internal air mode. The control unit 60 released from the rainwater cutoff mode 62 allows the intake door 18 to return to the original state.

The air conditioning system of the third embodiment described above is not provided with the rain detection unit 30 (see FIGS. 2 and 5) but is configured to enter the rainwater cutoff mode 62 and close the external air introduction port 12 if the vehicle speed data and the blower rotation speed level data satisfy all the reference conditions. Thus, it is possible to prevent rainwater from flowing into the external air introduction port 12 without having to use various kinds of sensors of the rain detection unit 30.

Accordingly, it is possible to provide an effect of saving costs. As result, the technique of preventing entry of rainwater into the external air introduction port 12 can be applied to a low-price motor vehicle. In general, a low-price motor vehicle employs a manual air conditioning system and does not employ a rain sensor, a solar radiation sensor and the like. Despite the omission of various kinds of sensors, it is possible for a low-price motor vehicle to employ the technique of preventing entry of rainwater into the external air introduction port 12.

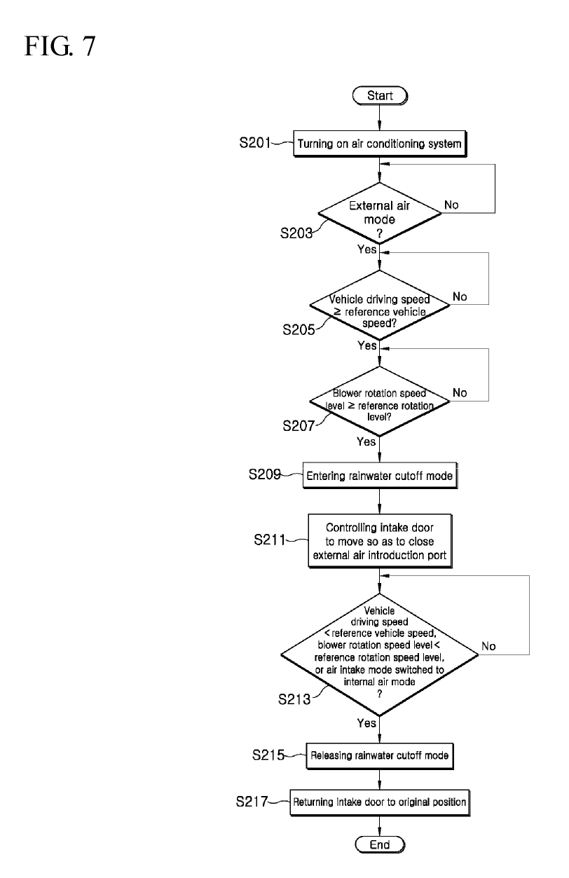

Next, an operation example of the air conditioning system of the third embodiment configured as above will be described with reference to FIG. 7.

First, the air conditioning system is turned on (S201). In this state, determination is made as to whether the air intake mode of the air conditioning system is an external air mode (S203). If it is determined that the air intake mode of the air conditioning system is the external air mode, the control unit 60 determines again whether the current vehicle driving speed is equal to or higher than a predetermined reference vehicle speed (S205). If it is determined that the current vehicle driving speed is equal to or higher than the reference vehicle speed, the control unit 60 determines again whether the rotation speed level of the blower 20 is equal to or higher than a predetermined reference rotation speed level (S207). If it is determined that the rotation speed level of the blower 20 is equal to or higher than the reference rotation speed level, the control unit 60 enter the rainwater cutoff mode 62 (S209). The control unit 60 entering the rainwater cutoff mode 62 controls the intake door 18 to move toward the internal air mode position (B) as illustrated in FIG. 6, thereby partially closing the external air introduction port 12 (S211). As the external air introduction port 12 is partially closed, the rainwater existing outside the vehicle room is prevented from flowing into the external air introduction port 12. It is therefore possible to prevent the failure, damage and erroneous operation of various kinds of electric devices and components attributable to the introduction of rainwater into the external air introduction port 12.

Under a state in which the intake door 18 is controlled as above, the control unit 60 determines again whether the vehicle driving speed is lower than the reference vehicle speed, whether the rotation speed level of the blower 20 is lower than the reference rotation speed level, or whether the air intake mode is switched to an internal air mode (S213).

If it is determined that the vehicle driving speed is lower than the reference vehicle speed, if it is determined that the rotation speed level of the blower 20 is lower than the reference rotation speed level, or if it is determined that the air intake mode is switched to the internal air mode, the control unit 60 is released from the rainwater cutoff mode 62 (S215).

The control unit 60 released from the rainwater cutoff mode 62 allows the intake door 18 to return to the original state (S217). Then, the intake door 18 returns to the original position and normally opens or closes the external air introduction port 12.

According to the present air conditioning system configured as above, if the weather condition and the driving condition satisfy predetermined conditions, it is determined that rainwater existing outside the vehicle room may possibly be introduced into the external air introduction port 12. In this case, the external air introduction port 12 is partially closed. It is therefore possible to reliably restrain rainwater existing outside the vehicle room from flowing into the external air introduction port 12 of the air conditioner case 10 in case of rain.

Furthermore, since the air conditioning system is configured to restrain rainwater existing outside the vehicle room from flowing into the external air introduction port 12 of the air conditioner case 10 in case of rain, it is possible to prevent the failure, damage and erroneous operation of various kinds of electric devices and components due to the introduction of rainwater.

While some preferred embodiments of the present invention have been described above, the present invention is not limited to these embodiments. It is to be understood that various changes and modifications may be made without departing from the scope of the invention defined in the claims.

For example, there has been described an example in which the control unit 60 enters the rainwater cutoff mode 62 and controls the intake door 18 only when a condition that the vehicle driving speed is equal to or higher than the reference vehicle speed and a condition that the rotation speed level of the blower 20 is equal to or higher than the reference rotation speed level are satisfied. Alternatively, the control unit 60 may enter the rainwater cutoff mode 62 and may control the intake door 18 when one of the aforementioned conditions is satisfied.

1. An air conditioning system for motor vehicles, comprising:
an air conditioner case (10) having an external air introduction port (12) and an internal air introduction port (14);
an intake door (18) rotatably installed in the air conditioner case (10) so as to open the external air introduction port (12) in an external air mode and open the internal air introduction port (14) in an internal air mode;
a blower (20) configured to draw an internal air or an external air through the external air introduction port (12) or the internal air introduction port (14) and to blow the internal air or the external air into a vehicle room; and
a control unit (60) configured to control the intake door (18) to move in such a direction as to close the external air introduction port (12) and to restrain entry of rainwater into the external air introduction port (12), if a rotation speed level of the blower (20) satisfies a predetermined rotation speed level condition in the external air mode.

2. The air conditioning system of claim 1, wherein the control unit (60) is configured to enter a rainwater cutoff mode and to control the intake door (18) in such a direction as to close the external air introduction port (12), if the rotation speed level of the blower (20) is equal to or higher than a predetermined reference rotation speed level in the external air mode.

3. The air conditioning system of claim 2, wherein the control unit (60) is configured to control the intake door (18) to move in such a direction as to close the external air introduction port (12) and to restrain entry of rainwater into the external air introduction port (12), if a vehicle driving speed satisfies a predetermined vehicle driving speed condition in the external air mode.

4. The air conditioning system of claim 3, wherein the control unit (60) is configured to enter the rainwater cutoff mode and to control the intake door (18) in such a direction as to close the external air introduction port (12), if the vehicle driving speed is equal to or higher than a predetermined reference vehicle speed in the external air mode and if the rotation speed level of the blower (20) is equal to or higher than the predetermined reference rotation speed level in the external air mode.

5. The air conditioning system of claim 4, further comprising:
a rain detection unit (30) configured to detect whether it is raining,
wherein the control unit (60) is configured to enter the rainwater cutoff mode and to control the intake door (18) in such a direction as to close the external air introduction port (12), only when the rain detection unit (30) detects that it is raining, even if the vehicle driving speed is equal to or higher than the predetermined reference vehicle speed and even if the rotation speed level of the blower (20) is equal to or higher than the predetermined reference rotation speed level.

6. The air conditioning system of claim 5, wherein the control unit (60) is configured to control the intake door (18) to move in such a direction as to close the external air introduction port (12) when entering the rainwater cutoff mode and is configured to control the intake door (18) to move toward a position between the external air introduction port (12) and the internal air introduction port (14) so that the external air introduction port (12) is partially closed.

7. The air conditioning system of claim 6, wherein the control unit (60) is configured to control the intake door (18) to close the external air introduction port (12) by about 30% when entering the rainwater cutoff mode.

8. The air conditioning system of claim 5, wherein after the control unit (60) enters the rainwater cutoff mode, the control unit (60) is configured to be released from the rainwater cutoff mode and to allow the intake door (18) to return to an original position, if the vehicle driving speed is lower than the predetermined reference vehicle speed, if the rotation speed level of the blower (20) is lower than the predetermined reference rotation speed level, if the rain detection unit (30) detects that it is not raining, or if an air intake mode is switched to the internal air mode.

9. The air conditioning system of claim 5, wherein the rain detection unit (30) is a rain sensor (32) installed on a windshield and configured to detect rainwater.

10. The air conditioning system of claim 5, wherein the rain detection unit (30) includes a solar radiation sensor (34) configured to detect a solar radiation amount, and a microcomputer (36) configured to determine that it is raining now, if the solar radiation amount detected by the solar radiation sensor (34) is equal to or smaller than a predetermined reference solar radiation amount.
